(19) United States
(12) Patent Application Publication
(10) Pub. No.: US 2012/0253968 A1
(43) Pub. Date: Oct. 4, 2012

(54) EFFICIENT CHOICE SELECTION IN A USER INTERFACE

(76) Inventors: Ronald Steven Cok, Rochester, NY (US); Joanne L. Body, San Francisco, CA (US); Sharon F. Rauch, El Cerrito, CA (US)

(21) Appl. No.: 13/075,435

(22) Filed: Mar. 30, 2011

(51) Int. Cl. G06Q 30/00

(52) U.S. Cl. 705/26.5

(57) ABSTRACT

A method for efficiently enabling a user to specify elements in a product includes providing a single user-interactive page in a graphic user interface that includes user selections. The method further includes receiving a user selection of at least one product element and providing at least two separate first product choices wherein each first product choice includes a representation of the selected product element. The method further includes receiving a user selection of one of the first product choices and providing at least two separate second product choices that-are shown to the user in the user-interactive page wherein each second product choice includes a representation of the selected product element and the selected first product choice, and receiving a user selection of one of the second product choices to specify the product with the product element, first product choice, and second product choice.

### FIELD OF THE INVENTION

The present invention relates to user interface design, and more particularly to efficiently selecting from among multiple attributes of a single image-based product.

### BACKGROUND OF THE INVENTION

Products that include images are a popular keepsake or gift for many people. Such image products typically include one or more pictures taken by an individual that is inserted into, or is otherwise a part, of another product to enhance the product, the presentation of the image, or to provide storage for the image. Examples of such image products include picture albums, posters, picture calendars, picture mugs, picture ornaments, picture mouse pads, and picture post cards.

Many such image products include a variety of options that can be included with the image product or that affect the appearance or utility of the image product. For example, an image print can be made in a variety of sizes, in a variety of arrangements, with various artistic enhancements such as templates, and on a variety of photographic papers. In another example, an image print can be framed with a matte surround. In such cases, a customer must not only select an image, but must also select the other attributes of the image product, for example the matte, the frame, the arrangement of the image(s), the size, or the photographic paper type. Some of the attributes available to the customer will depend on the selection of other attributes, for example a matte or frame of a particular size can complement an image print of a corresponding size or color.

In computer-based, on-line shopping environments, for example in web-based businesses such as the Kodak Gallery, users interact with client computers that are connected through the internet to remote server computers. The server computers provide information to the remote client computers presented in graphic user interfaces. The information is often specified in hypertext markup language (html) that defines pages in the world-wide web and is useful for making product selections and responding to user operations to specify the product and any related options. Images of sample products can be shown to the user in the graphic user interfaces to aid selection as well as views of sample products incorporating user images. Once the user selects the appropriate product, provides the desired image(s), and specifies the various attributes associated with the selected product and image(s), the product information can be sent to an image fulfillment system and the product manufactured, for example as described in U.S. Pat. Nos. 6,370,280 and 6,147,742.

Because the graphic user information is provided from a remote computer through a computer network, user interface responsiveness is an important concern. It can take a perceptible time for a user to navigate from one page to the next, particularly if large amounts of data, such as images, are communicated between the server computer and the client computer. Furthermore, multiple display pages are often employed that make it difficult for a user to visualize and compare the desired product, product elements, product attributes, or product options and it is therefore difficult for the user to make a selection.

There is a need, therefore, for user interface designs, computer systems, and methods that enable a user to efficiently select products and product attributes in a computing environment.

### SUMMARY OF THE INVENTION

In accordance with the present invention, there is provided a method for efficiently enabling a user to specify elements in a product to specify the product comprising:

using a processor to provide a single user-interactive page in a graphic user interface that includes user selections shown to a user;

receiving a user selection of at least one product element and providing at least two separate first product choices that are shown to the user in the user-interactive page wherein each first product choice includes a representation of the selected product element;

receiving a user selection of one of the first product choices and providing at least two separate second product choices that are shown to the user in the user-interactive page wherein each second product choice includes a representation of the selected product element and the selected first product choice; and

receiving a user selection of one of the second product choices to specify the product with the product element, first product choice, and second product choice.

Another aspect of the present invention includes a user interface for efficiently enabling a user to specify elements in a product to specify the product comprising:

a processor for generating a single user-interactive page in a graphic user interface that includes user selections shown to a user;

the processor enabling a user selection of at least one product element and a display showing at least two separate first product choices to the user in the user-interactive page wherein each first product choice includes a representation of the selected product element;

the processor enabling a user selection of one of the first product choices and the display showing at least two separate second product choices to the user in the user-interactive page wherein each second product choice includes a representation of the selected product element and the selected first product choice; and

the processor enabling a user selection of one of the second product choices to specify the product with the product element, first product choice, and second product choice.

In yet another aspect of the present invention a computer system for efficiently enabling a user to specify elements in a product to specify the product comprises:

a server computer connected to a remote client computer through a computer network, the server computer including storage for one or more user-interface specifications in a graphic user interface that are communicated through the computer network to the remote client computer, the remote client computer having a display for displaying the user-interface specifications, and at least one of the user-interface specifications including a single user-interactive page in a graphic user interface that includes user selections shown to a user;

wherein the display shows a single user-interactive page including a user selection of at least one product element and at least two separate first product choices and each first product choice includes a representation of the selected product element;

wherein the display shows the single user-interactive page including a user selection of one of the first product choices and at least two separate second product choices and each second product choice includes a representation of the selected product element and the selected first product choice; and

wherein the display shows the single user-interactive page including a user selection of one of the second product choices to specify the product with the product element, first product choice, and second product choice.

In a further aspect of the present invention a method for efficiently enabling a user to specify elements in a product to specify the product comprises:

providing a server computer connected to a remote client computer through a computer network, the server computer including storage for one or more user-interface specifications in a graphic user interface that are communicated through the computer network to the remote client computer, the remote client computer having a display for displaying the user-interface specifications, and at least one of the user-interface specifications including a single user-interactive page in a graphic user interface that includes user selections shown to a user;

using the server computer to include a user selection of at least one product element and at least two separate first product choices in the single user-interactive page that are shown to the user in the user-interactive page and each first product choice includes a representation of the selected product element;

using the server computer to include a user selection of one of the first product choices and at least two separate second product choices in the single user-interactive page that are shown to the user in the user-interactive page and each second product choice includes a representation of the selected product element and the selected first product choice; and

using the server computer to include a user selection of one of the second product choices in the user-interactive page to specify the product with the product element, first product choice, and second product choice.

These, and other, attributes of the present invention will be better appreciated and understood when considered in conjunction with the following description and the accompanying drawings. It should be understood, however, that the following description, although indicating embodiments of the present invention and numerous specific details thereof, is given by way of illustration and not of limitation. For example, the summary descriptions above are not meant to describe individual separate embodiments whose elements are not interchangeable. Many of the elements described as related to a particular embodiment can be used together with, and possibly interchanged with, elements of other described embodiments. The figures below are intended to be drawn neither to any precise scale neither with respect to relative size, angular relationship, or relative position nor to any combinational relationship with respect to interchangeability, substitution, or representation of an actual implementation.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1 illustrates a user-interactive page according to an embodiment of the present invention;

FIG. 2 illustrates an alternative user-interactive page according to an embodiment of the present invention;

FIG. 3 illustrates a multi-image product;

FIG. 4 is a flow diagram of a method according to an embodiment of the present invention;

FIG. 5 is a flow diagram of another method according to an embodiment of the present invention;

FIG. 6 is a schematic of an embodiment of a system for generating an image product;

FIG. 7 is an illustration of an embodiment of a desktop computer, work station, or kiosk that can be used in a system of FIG. 6; and

FIGS. 8a, 8b, and 8c illustrate alternative arrangements of a user-interactive page according to embodiments of the present invention.

### DETAILED DESCRIPTION OF THE INVENTION

According to the present invention, an image product is a product that includes a user's personalized images incorporated into an image-related object, such as for example a photo-book, a picture greeting card, a picture mug, or other image-related product. A framed print of an image or picture, with or without a matte, also forms an image-related product. The images can be positioned in specified pre-determined locations or can be adaptively positioned according to the sizes, attribute ratios, orientations and other attributes of the images or image-related product. Likewise, the image sizes, orientations, or attributes included in the image product can be adjusted, either to accommodate pre-defined templates with specific pre-determined openings or adaptively adjusted for inclusion in an image product. For example, an image selected by a user can be cropped, reduced in size, or enlarged, either automatically according to an algorithm or manually by the user.

Image products can be interactively specified on a computer terminal, for example on a remote client computer connected through the internet to a server computer. The server computer can provide web pages in the world-wide web (for example specified in hypertext markup language) that are transferred to the client computer and presented to a user. The user then interacts with the web pages to make appropriate selections and specify an image product. The selections are communicated to the server and the product is made and delivered.

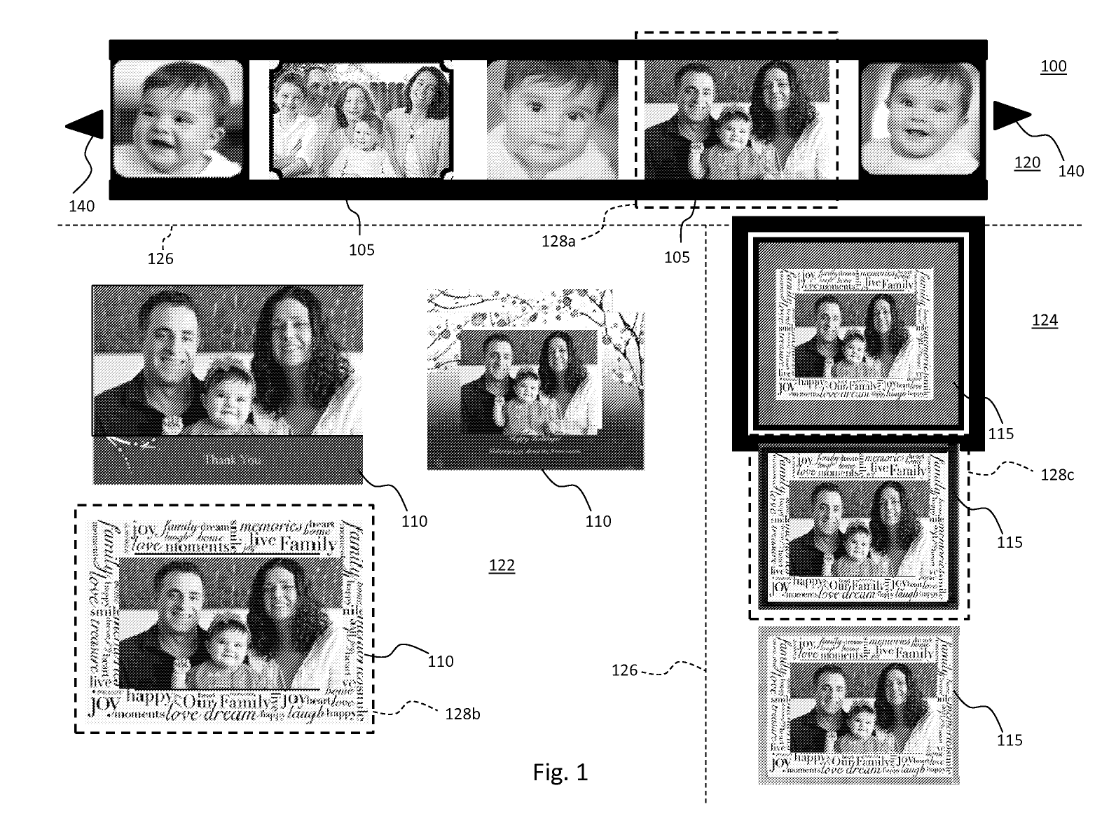

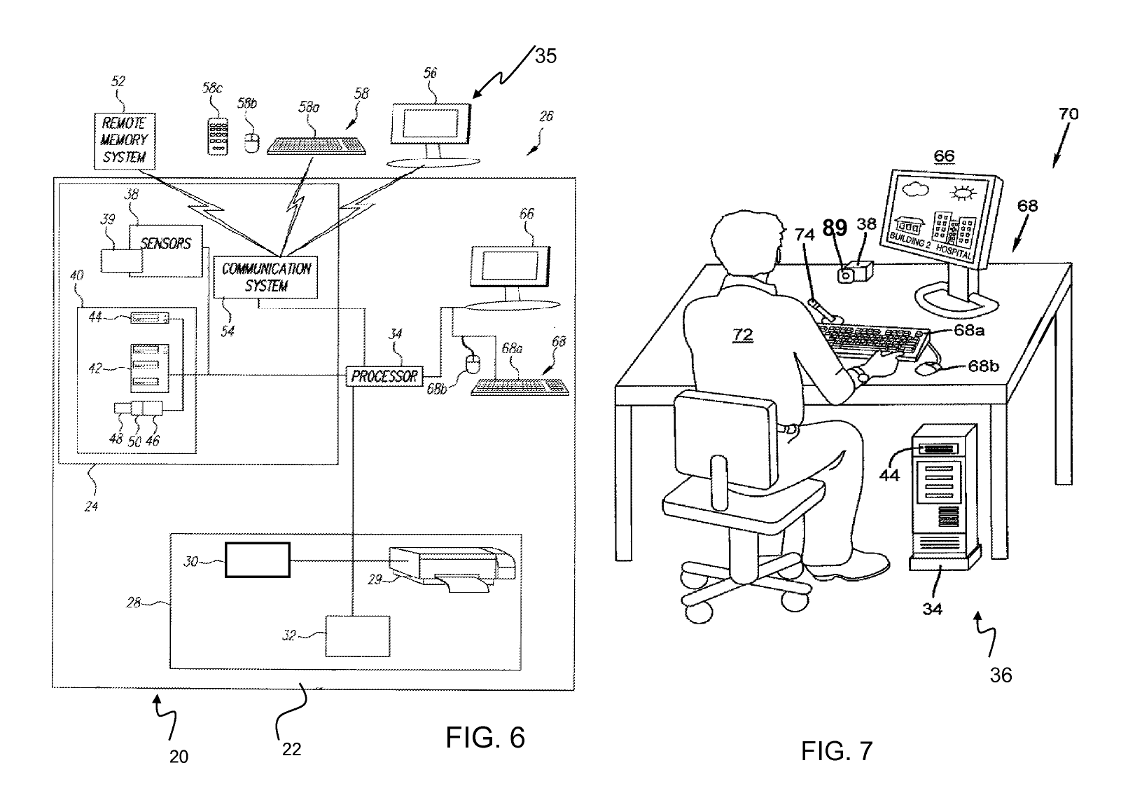

It is important to efficiently and intuitively present image product options to a user to enable efficient and effective choices in the process of making appropriate selections and image product specifications. Referring to FIG. 1 and also to FIGS. 6 and 7, in an embodiment of the present invention a user interface for efficiently enabling a user 72 to specify elements in a product to specify the product includes a processor 34 for generating a single user-interactive page 100 in a graphic user interface (e.g. shown on local display 66) that includes user selections shown to the user 72. A page can also be considered to be a screen of information presented on a display screen. As intended herein, a page includes information content that is viewable at one moment by the user 72 on one or more displays (e.g. 66). The user selections include product elements 105, first product choices 110, and second product choices 115 that, taken together, specify options for an image product or a portion of an image product.

Two or more product elements 105 are presented on the single user-interactive page 100, each product element 105 having two or more first product choices 110, and each first product choice 110 having two or more second product choices 115, wherein the product elements 105 are presented as selectable graphic icons on a first portion 120 of the single user-interactive page 100, the first product choices 110 are presented as selectable graphic icons on a second portion 122 of the single user-interactive page 100, and the second product choices 115 are presented as selectable graphic icons on a third portion 124 of the single user-interactive page 100. Each of the selectable graphic icons for the first product choices 110 includes a representation of the selected product element 105 and each of the selectable graphic icons for the second product choices 115 includes a representation of the selected product element 105 and the selected first product choice 110. A complete product includes all of the product element 105, first product choices 110, and second product choices 115.

The processor 34 enables a user selection of at least one product element 105 and a display (e.g. 66) showing at least two separate first product choices 110 to the user 72 in the user-interactive page 100. The processor 34 also enables a user selection of one of the first product choices 110 and the display 66 shows at least two separate second product choices 115 to the user 72 in the user-interactive page 100. Each second product choice 115 includes a representation of the selected product element 105 and the selected first product choice 110. The processor 34 further enables a user selection of one of the second product choices 115 to specify the product with the product element 105, first product choice 110, and second product choice 115.

As used herein, when the processor 34 or display 66 shows the product element 105, first product choice 110, or second product choice 115, the processor 34 communicates with the display 66 so that the display 66 represents or displays an image of the product element 105, first product choice 110, or second product choice 115, for example as an icon or thumbnail image. The image of the product element 105, first product choice 110, or second product choice 115 is not the product element 105, first product choice 110, or second product choice 115 itself, but a representation of the product element 105, first product choice 110, or second product choice 115 on the display as controlled by the processor 34. When the product element 105 is represented in the first product choice 110, the representation of the first product choice 110 includes the product element 105, for example by compositing an image of the product element 105 into an image of the first product choice 110. Similarly, when the product element 105 and the first product choice 110 is represented in the second product choice 115, the representation of the second product choice 115 includes the product element 105 and first product choice 110, for example by compositing an image of the product element 105 and an image of the first product choice 110 into an image of the second product choice 115.

The product elements 105 can be image products. As used herein, product elements 105, first product choices 110, or second product choices 115 serve to specify various attributes or options of a product. The designation of product element 105, first product choice 110, or second product choice 115 of an attribute or option of a complete product can be arbitrary. For example, a complete product can be an image print provided with a matte surround in a frame. In one embodiment, the product element 105 can be an image print, the first product choice 110 can be the matte, and the second product choice 115 can be the frame. This is useful if the user 72 first wishes to select an image, then match a matte to the image, and a frame to the image and matte. In an alternative embodiment, the user 72 can desire to select a frame and then match an image and matte to the frame. In this alternative embodiment, the product element 105 can be the frame, the first product choice 110 an image, and the second product choice 115 the matte.

According to an embodiment of the present invention, the product element 105 can be presented as any attribute or option of a complete product, while the first product choices 110 and second product choices 115 can be other attributes or options of the complete product. A selection of one product element 105, first product choice 110, or second product choice 115 can limit the selection of other attributes or options in the complete product. For example, a specific matte can only be available with a subset of frames, or vice versa. Alternatively, a frame or matte might be available only in a certain size of image print. The selection of print size, therefore, can limit the choices of frame or matte.

In an embodiment of the present invention, the product elements 105, first product choices 110, or second product choices 115 form a hierarchy of selectable attributes of a complete product, and the structure of the hierarchy can be chosen to match the desired user selection process. For example, if the selection of an image is the first choice the user 72 desires to make, the image can be presented as the product element 105, if the selection of an image matte is the second choice the user 72 desires to make, the mattes can be presented as the first product choices 110, and if the frame is the third choice the user 72 desires to make, the frame can be presented as the second product choice 115. In an embodiment of the present invention, the user 72 can specify the selection hierarchy, thereby defining the product element 105, first product choice 110, and second product choice 115 for a desired complete product. This, in turn will specify the selections and content of portions on single user-interactive page, including the location of information content in the single-user interactive page.

In an alternative embodiment, for example, the product element 105 can be a card, card templates can be the first product choices 110, and images can be the second product choices 115. As noted above, the designations of product element 105, first product choice 110, and second product choice 115 can be arbitrary, so that any of the six arrangements of the card, the template, and the images can specify the product element 105, the first product choice 110, and the second product choice 115 (e.g. card, template, image; card, image, template; template, card, image; template, image, card; image, template, card; image, card, template).

Referring again to the embodiment of FIG. 1, the user 72 is presented with a single, user-interactive page 100. The product element 105 is indicated by the user 72, for example with a selection box 128a, the first product choice 110 is indicated with a selection box 128b, and the second product choice 115 is indicated with a selection box 128c. The selections can be indicated using other ways, for example highlighting the selected product element 105, first product choice 110, or second product choice 115. Graphic user interface methods for selecting graphic elements are known in the art. As shown in FIG. 1, the product element 105 is an image, the first product choices 110 are matte or template designs surrounding the image, and the second product choices 115 are frames mounting the selected image and matte or template design. The selected image (i.e. product element 105) is incorporated into, and presented with, the design templates (i.e. first product choice 110), and the selected image and design template are incorporated into, and presented with, the frame (i.e. second product choice 115).

The images are presented, according to an embodiment, in a slide show as the product elements 105 in the first portion 120 of the single, user-interactive page 100. The design template elements are presented as the first product choices 110 in the second portion 122 of the single, user-interactive page 100, and the frames are presented as the second product choices 115 in the third portion 124 of the single, user-interactive page 100. The portions of the single, user-interactive page are divided by dashed lines 126, for clarity of illustration. In one embodiment, such lines 126 can be presented in the single, user-interactive page 100 to clarify the page first, second and third portions 120, 122, 124 and to enable graphic control commands or graphic actions to adjust the relative sizes and locations of the page first, second and third portions 120, 122, 124 in the single, user-interactive page 100 (for example by dragging the lines 126 from one location on the single, user-interactive page 100 to another location). In this embodiment, the first, second and third portions 120, 122, 124 must be contiguous in the single, user-interactive page 100. In another embodiment, the lines 126 are not presented in the single, user-interactive page 100.

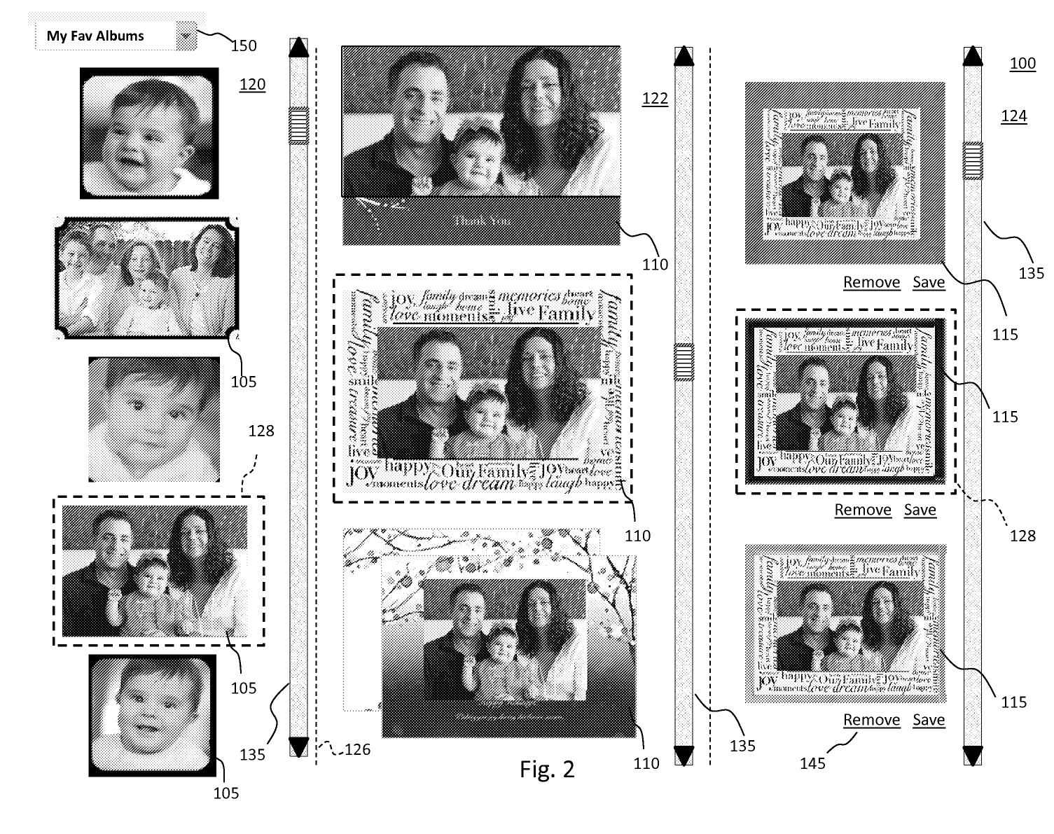

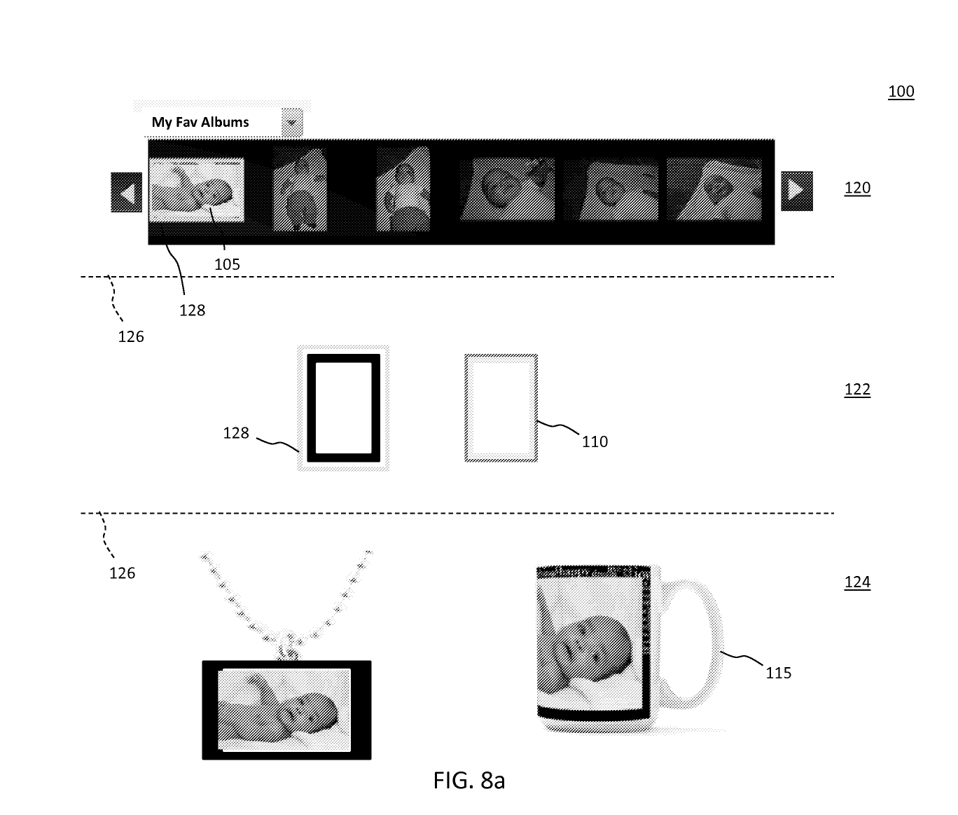

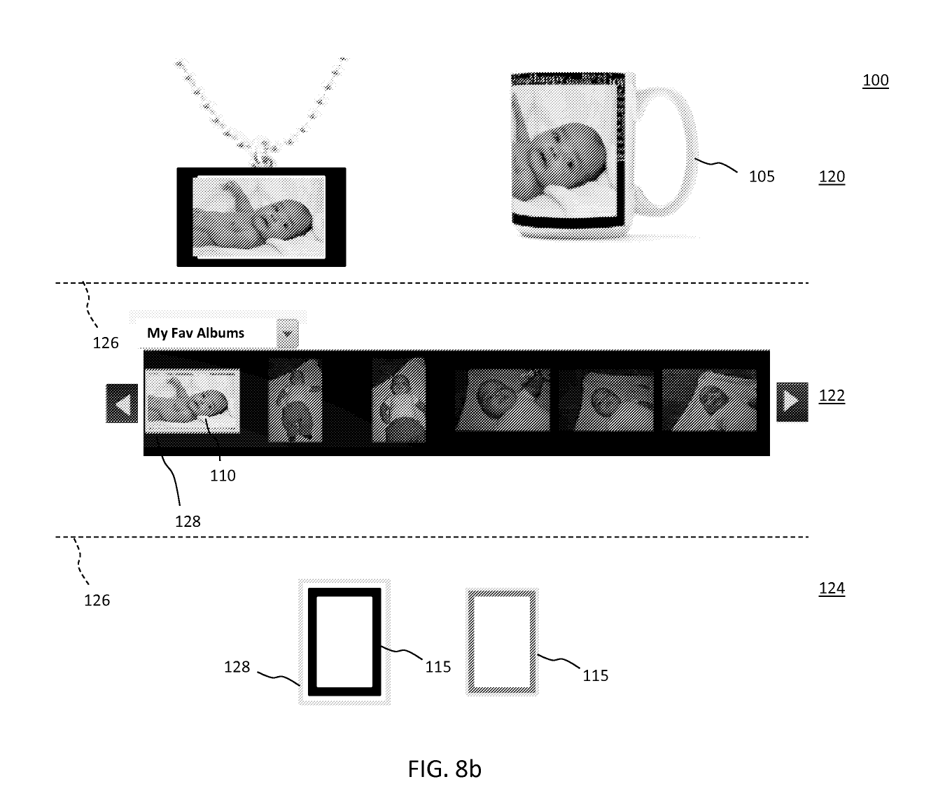

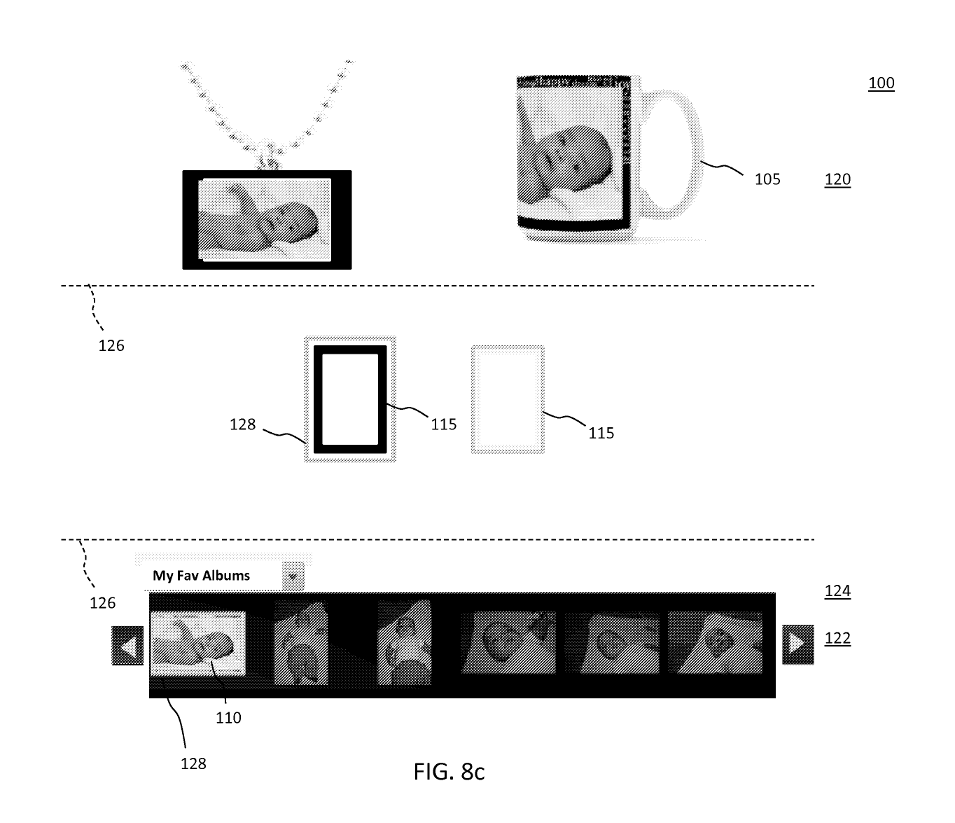

In the embodiment illustrated in FIG. 1, the image product elements 105 in first portion 120 are located at the top of the single, user-interactive page 100, the first product choices 110 in second portion 122 are located at the left side of the single, user-interactive page 100, and the second product choices 115 in third portion 124 are located on the right side of the single, user-interactive page 100. Referring to FIG. 2, the image product elements 105 are located in first portion 120 at the left of the single, user-interactive page 100, the first product choices 110 are located in second portion 122 at the center of the single, user-interactive page 100, and the second product choices 115 in third portion 124 are located on the right side of the single, user-interactive page 100. FIGS. 8a, 8b, and 8c, discussed below, locate the first, second and third portions 120, 122, 124 at the top, middle, and bottom, respectively of the single, user-interactive page 100. Although the first, second and third portions 120, 122, 124 and the corresponding product elements 105, first product choices 110, and second product choices 115, can be positioned in various locations, it can be useful to position the product elements 105, first product choices 110, and second product choices 115 in locations corresponding to the hierarchy order and likely order of selection. In English-speaking countries for example, reading is done from the top down and from left to right on a page; therefore positioning the first, second and third portions 120, 122, 124 of the selection hierarchy in locations corresponding to the natural reading order for English speakers is a useful embodiment, as illustrated in FIGS. 1, 2, 8a, 8b, and 8c. In other cultures, for example Arabic cultures, reading is done from right to left and, in other embodiments of the present invention, the first, second and third portions 120, 122, 124, can be correspondingly located from right to left.

Referring to FIG. 2, in various embodiments of the present invention, the number of product elements 105, first product choices 110, or second product choices 115 in a complete product can be larger than the area available in a single, user-interactive page 100. To enable selection from a large number of choices in a portion of the single, user-interactive page 100, scroll bars 135 can be used to scroll the contents of one of the first, second or third portions 120, 122, 124 or the user-interactive page 100. Graphic icons such as arrowhead symbols 140 (shown in FIG. 1), particularly if images are shown in a slideshow fashion, can also be used to scroll the images to the left or right (or up and down) in an ordered fashion. The number of product elements 105, first product choices 110, or second product choices 115 shown in portions 120, 122, 124 can also be controlled by changing the sizes of the first, second and third portions 120, 122, 124 as noted above.

In a useful embodiment of the present invention, product elements 105, first product choices 110, or second product choices 115 can be collected into a group. The collected groups of choices are then presented as the product elements 105, first product choices 110, or second product choices 115 in the single, user-interactive page 100. For example, a collected group of images can be taken from a user-defined set of related images (often called an ‘album’). The choices presented to the user 72 are then taken from a specified collection, for example using a graphic selection device such as a pull-down menu 150 in FIG. 2 to indicate the desired collection. In other embodiments, items can be removed from a collection to reduce the number of choices presented, for example with a selection box or a graphic command 145 indicating the inclusion of the element in the display list.

In an embodiment of the present invention, representations of products with the desired selections can be saved for later comparison with other representation products resulting from other choices.

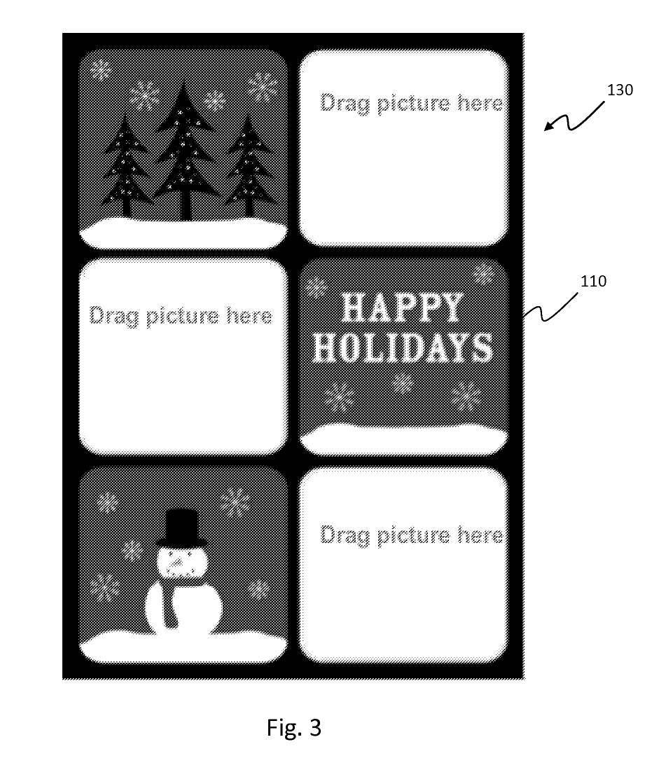

In a further embodiment of the present invention, an image product can be a multi-image product 130 with a multi-image template serving as the first product choice 110, as shown in FIG. 3. Multiple product elements 105, first product choices 110, or second product choices 115 can be made, for example with selection boxes (128 in FIG. 2), to specify the multiple items necessary to define the product attributes.

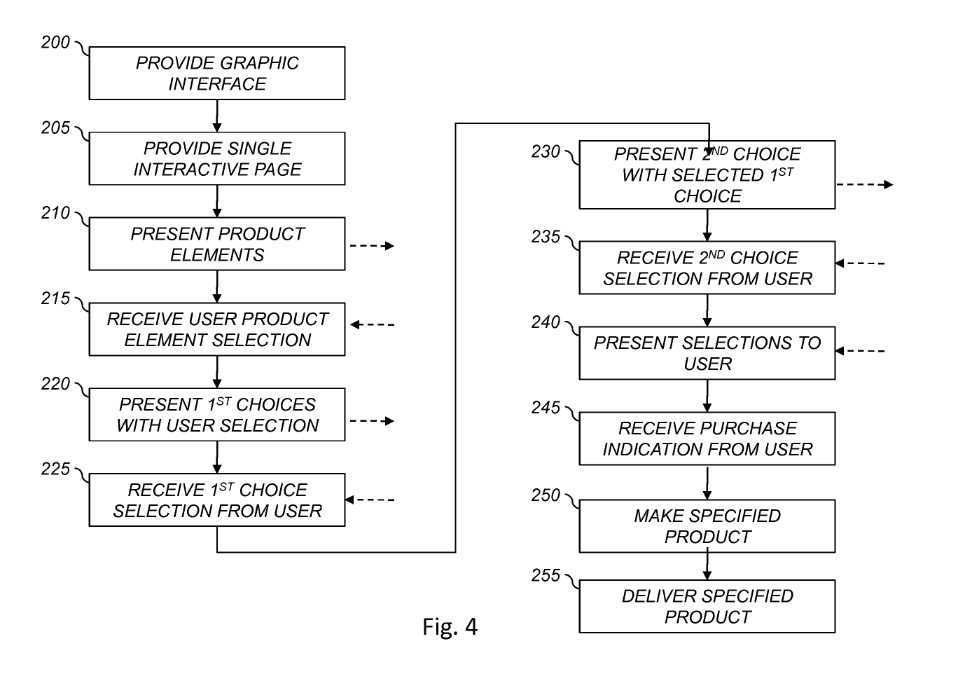

Referring to FIG. 4, in a method according to an embodiment of the present invention, the processor 34 is used to provide a graphic interface in step 200. The graphic interface can be communicated from a server to a client computer through the internet and can be a web page served by the server computer and viewed with a browser on the client computer. Alternatively, the graphic interface can be a user interface provided by a computer program executing on a computer. In an embodiment, the program can communicate with remote computers. Other ways of providing graphic user interfaces can be employed, as are known to practitioners of the computer sciences. The graphic interface is used to provide a single, user-interactive page 100 in a graphic user interface (step 205). As intended herein, a single, user-interactive page 100 can also be considered as one or more screens of information, or a presentation of information on one or more displays 66, all of which are visible at one moment in time.

Within the single, user interactive page 100, product elements 105 are presented (step 210) on the display 66 under the control of the processor 34. The user 72 then interacts with the single, user interactive page 100 to make a selection from among the product elements 105. This interaction can be done using methods known in the art, for example by clicking a pointing device (e.g. mouse, trackball, or touchpad) button on a graphic icon representing a desired choice when the pointing device points to the corresponding graphic icon.

Once the user 72 has indicated a product element 105 selection and the selection is received (step 215), the single user-interactive page 100 is updated to illustrate the first product choices 110 with the selected product element 105 to the user 72 (step 220). For example, if the product element 105 is an image and the first product choices 110 are templates, the selected image is composited into the template choices and each template and selected image is shown together in the single, user-interactive page 100 on display 66. By showing the templates with the image, the user 72 can more readily visualize the various attributes of the complete product. The user 72 then selects the first product choice 110 and the first product choice 110 is received (step 225).

The process is then repeated for the second product choices 115. The representations of the second product choices 115 are updated to include the selected product element 105 and the selected first product choice 110 (step 230). The user 72 interacts with the single, interactive page 100 to make a selection from among the second product choices 115. This interaction can be done as indicated above on a representative graphic icon when the pointing device points to the corresponding graphic icon. Once the user 72 has indicated the second product choice 115 and the choice received (step 235), the page is updated to illustrate the second product choices 115 with the selected element 105 and selected first product choice 110 (step 240). The user 72 then indicates a purchase decision (step 245) and the selected product is made (step 250) and delivered (step 255).

If the user 72 desires to make selections from first product choices 110 or second product choices 115 before the product element 105 (e.g. select a frame or template first, then select an image), methods well known in the art can be provided to exchange the order in which selections can be made. For example, if a user selects a frame first, the images and templates can be represented with the selected frame. If the user 72 selects a template first, the frames and image choices can be represented with the selected template. In another embodiment of the present invention, any of the product elements 105, the first product choices 110, or second product choices 115 can be selected first, second, or third. As each attribute is selected, the representations of the other elements or choices are modified to include whichever attributes have been selected. As noted above, the designation of product element 105, first product choices 110, and second product choices 115 can be arbitrary. Hence, according to an embodiment of the present invention, the order of selection from among the product elements 105, first product choices 110, and second product choices 115 can likewise be arbitrary as can the position of the product elements 105, first product choices 110, and second product choices 115 in the single, user-interactive page 100. The arrows in FIG. 4 indicate that the user 72 can choose to perform the various steps in different orders and that the representations of the product elements 105, first product choices 110, and the second product choices 115 are updated in the single, user-interactive page 100 on the display 66 after each selection step.

Referring to FIGS. 8a, 8b, and 8c, a single, user-interactive page 100 includes product elements 105, first product choices 110, and second product choices 115. In FIG. 8a, images in a slideshow are presented as the product elements 105 in first portion 120 at the top of the single, user-interactive page 100, borders are presented as the first product choices 110 in the second portions 122 at the center of the single, user-interactive page 100, and mugs or pendants as the second product choices 115 in third portion 124 at the bottom of the single, user-interactive page 100. An image and border are shown with selection box 128. In FIG. 8b, mugs or pendants are shown as the product elements 105 in first portion 120, images in a slideshow are presented as the first product choices 110 in second portion 122 at the center of the single, user-interactive page 100, and borders are presented as the second product choices 115 in the third portion 124. In FIG. 8c, the positions of the first product choices 110 (images) and second product choices 115 (borders) are exchanged. Once the selections are made, the complete product can be specified and constructed. FIGS. 8a, 8b, and 8c provide the same functionality, but with differently designated product elements 105, first product choices 110, and second product choices 115 positioned in different portions and locations in the single, user-interactive page 100. Any such arrangements are considered to be different embodiments of the present invention.

Selections once made can be modified or repeated. For example, the user 72 can decide to modify a product element 105 after a first or second product choice selection has been made, thus returning to step 215 (FIG. 4). Similarly, the user 72 can decide to modify a first product choice selection after a product element or second product choice selection has been made, thus returning to step 225. The user can also return to step 235 to change a selection of the product element or first product choice. In short, the user 72 can change any of the product element 105, first product choice 110, or second product choice 115 selections before indicating a desire to purchase the specified product in step 245. Whenever a selection or change is made, the single, user-interactive page 100 is updated by representing the product elements (step 210), first product choices (step 220) or second product choices (step 230), as appropriate depending on which selection was made or modified. For example, if the user 72 has selected an image and a frame, the representation of the templates can include the selected image and frame. The control of user interfaces to respond to user selections of graphic elements in a page is well known in the art and tools for implementing such user interfaces are readily available on various graphic user interface computers.

The present invention provides a method of making product attribute selections where the products include multiple attributes and choices. By presenting all (or at least more than one) of the attributes on a single page, page navigation is reduced. By incorporating any of the selected product elements, elements, or attributes into the representation of the product, users 72 can readily envision the product with the choices made. By enabling the choice of product, element, or attribute on a single page, the user 72 can readily experiment and compare choices to select the desired one. If desired, in another embodiment, a mechanism for saving choices for later comparison with other choices can be provided.

As shown in FIG. 6 and according to another embodiment of the present invention, a computer system for efficiently enabling the user 72 to specify elements in a product to specify the product includes a electronic computer system 20, for example a computer server, connected to a remote electronic computer system 35, for example a client computer through a computer network, the electronic computer system 20 including memory 40 for one or more user-interface specifications in a graphic user interface that are communicated through the computer network to the remote electronic computer system 35, the remote electronic computer system 35 having the display 66 (FIG. 7) for displaying the user-interface specifications, and at least one of the user-interface specifications including a single user-interactive page 100 in a graphic user interface that includes user selections shown to the user 72. The display 66 shows a single user-interactive page 100 including a user selection of at least one product element 105 and at least two separate first product choices 110 and each first product choice 110 includes a representation of the selected product element 105. The display 66 shows the single user-interactive page 100 including a user selection of one of the first product choices 110 and at least two separate second product choices 115 and each second product choice 115 includes a representation of the selected product element 105 and the selected first product choice 110. The display 66 shows the single user-interactive page 100 including a user selection of one of the second product choices 115 to specify the product with the product element 105, first product choice 110, and second product choice 115.

FIG. 6 illustrates an embodiment of an electronic computer system 20, for example a computer, which can be used in generating an image product. In the embodiment of FIG. 6, the electronic computer system 20 includes a source of content data files 24, a user input system 26 and an output system 28 connected to the processor 34. The source of content data files 24, user-input system 26 or output system 28 and processor 34 can be positioned within a housing 22 as illustrated. In other embodiments, circuits and systems of the source of content data files 24, user input system 26 or output system 28 can be positioned in whole or in part outside of housing 22.

The source of content data files 24 can include any form of electronic or other circuit or system that can supply digital data to processor 34 from which processor 34 can derive images for use in forming an image-enhanced item. In this regard, the content data files can include, for example and without limitation, still images, image sequences, video graphics, and computer-generated images. Source of content data files 24 can optionally capture images to create content data for use in content data files by use of capture devices located at, or connected to, electronic computer system 20 or can obtain content data files that have been prepared by or using other devices such as the remote electronic computer system 35. In the embodiment of FIG. 6, source of content data files 24 includes sensors 38, the memory 40 and a communication system 54.

Sensors 38 are optional and can include light sensors, biometric sensors and other sensors known in the art that can be used to detect conditions in the environment of electronic computer system 20 and to convert this information into a form that can be used by processor 34 of electronic computer system 20. Sensors 38 can also include one or more image sensors 39 that are adapted to capture still or video images. Sensors 38 can also include biometric or other sensors for measuring involuntary physical and mental reactions such sensors including, but not limited to, voice inflection, body movement, eye movement, pupil dilation, body temperature, and p4000 wave sensors. Memory 40 can include conventional memory devices including solid-state, magnetic, optical or other data-storage devices. Memory 40 can be fixed within electronic computer system 20 or it can be removable. In the embodiment of FIG. 6, electronic computer system 20 is shown having a hard drive 42, a disk drive 44 for a removable disk such as an optical, magnetic or other disk memory (not shown) and a memory card slot 46 that holds a removable memory 48 such as a removable memory card and has a removable memory interface 50 for communicating with removable memory 48. Data including, but not limited to, control programs, digital images and metadata can also be stored in a remote memory system 52 such as the remote electronic computer system 35, a personal computer, computer network or other digital system. Remote memory system 52 can also include solid-state, magnetic, optical or other data-storage devices.

In the embodiment shown in FIG. 6, electronic computer system 20 has a communication system 54 that in this embodiment can be used to communicate with remote electronic computer systems 35 for example including an optional remote memory system 52, an optional remote display 56, or optional remote input 58 (also referred to herein as “remote input 58”). The optional remote memory system 52, optional remote display 56, and optional remote input 58 can all be part of the remote electronic computer system 35 having an remote input 58 with remote input controls, and that can communicate with communication system 54 wirelessly as illustrated or can communicate in a wired fashion. In an alternative embodiment, a local input station including either or both of the local display 66 and local input controls 68 (also referred to herein as “local user input 68”) can be connected to communication system 54 using a wired or wireless connection.

Communication system 54 can include for example, one or more optical, radio frequency or other transducer circuits or other systems that convert image and other data into a form that can be conveyed to a remote device such as a remote memory system 52 or a remote display 56 using an optical signal, radio frequency signal or other form of signal. Communication system 54 can also be used to receive a digital image and other data from a host or server computer or network (not shown), the remote memory system 52 or the remote input 58.

Communication system 54 provides processor 34 with information and instructions from signals received thereby. Typically, communication system 54 will be adapted to communicate with the remote memory system 52 by way of a communication network such as a conventional telecommunication or data transfer network such as the internet, a cellular, peer-to-peer or other form of mobile telecommunication network, a local communication network such as wired or wireless local area network or any other conventional wired or wireless data transfer system. In one useful embodiment, the electronic computer system 20 can provide web access services to remote electronic computer systems 35 that access the electronic computer system 20 through a web browser. Alternatively, the remote electronic computer system 35 can provide web services to electronic computer system 20 depending on the configurations of the systems.

User input system 26 provides a way for a user of electronic computer system 20 to provide instructions to processor 34. This permits the user 72 to make a designation of content data files to be used in generating an image-enhanced output product and to select an output form for the output product. User input system 26 can also be used for a variety of other purposes including, but not limited to, permitting the user 72 to arrange, organize and edit content data files to be incorporated into the image-enhanced output product, to provide information about the user or audience, to provide annotation data such as voice and text data, to identify characters in the content data files, and to perform such other interactions with electronic computer system 20 as are described herein.

In this regard user input system 26 can include any form of transducer or other device capable of receiving an input from the user 72 and converting this input into a form that can be used by processor 34. For example, user input system 26 can include a touch screen input, a touch pad input, a 4-way switch, a 6-way switch, an 8-way switch, a stylus system, a trackball system, a joystick system, a voice recognition system, a gesture recognition system a keyboard, a remote control or other such systems. In the embodiment shown in FIG. 6, user input system 26 includes an optional remote input 58 including a remote keyboard 58a, a remote mouse 58b, and a remote control 58c and a local user input 68 including a local keyboard 68a and a local mouse 68b.

Remote input 58 can take a variety of forms, including, but not limited to, the remote keyboard 58a, remote mouse 58b or remote control handheld device 58c illustrated in FIG. 6. Similarly, local user input 68 can take a variety of forms. In the embodiment of FIG. 6, local display 66 and local user input 68 are shown directly connected to processor 34.

As is illustrated in FIG. 7 local user input 68 can take the form of an editing area 70 such as a home computer, an editing studio, or kiosk that can also be the remote electronic computer system 35 or the electronic computer system 36. In this illustration, the user 72 is seated before a console including local keyboard 68a and mouse 68b and a local display 66 which is capable, for example, of displaying multimedia content, for example in a graphic user interface. As is also illustrated in FIG. 7, editing area 70 can also have sensors 38 including, but not limited to, image sensors 89, audio sensors 74 and other sensors such as multispectral sensors that can monitor user 72 during a production session or provide other information such as images.

Output system 28 (FIG. 6) is used for rendering images, text or other graphical representations in a manner that permits image-product designs to be combined with user items and converted into an image product. In this regard, output system 28 can include any conventional structure or system that is known for printing or recording images on output device 32 including, but not limited to, printer 29. Printer 29 can record images on a tangible surface 30 using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology, drop-on-demand inkjet technology and continuous inkjet technology. For the purpose of the following discussions, printer 29 will be described as being of a type that generates color images. However, it will be appreciated that this is not necessary and that the claimed methods and apparatuses herein can be practiced with the printer 29 that prints monotone images such as black and white, grayscale, or sepia toned images. As will be readily understood by those skilled in the art, the electronic computer system 36, 20 with which the user 72 interacts to define a user-personalized image product can be separated from the remote electronic computer system 35) connected to the printer 29, so that the specification of the image product is remote from its production.

In certain embodiments, the source of content data files 24, user input system 26 and output system 28 can share components.

Processor 34 operates electronic computer system 20 based upon signals from user input system 26, sensors 38, memory 40 and communication system 54. Processor 34 can include, but is not limited to, a programmable digital computer, a programmable microprocessor, a programmable logic processor, a series of electronic circuits, a series of electronic circuits reduced to the form of an integrated circuit, or a series of discrete components.

The electronic computer systems 20, 36 of FIGS. 6 and 7 can be employed to make an image product. Hence, according to an embodiment of the present invention, the electronic computer system 20 or 36 for enabling efficient choice selection, includes the electronic computer system 20 connected to the remote electronic computer system 35 through a computer network, the electronic computer system 20 including memory (e.g. 40) for one or more user-interface specifications in a graphic user interface that are communicated through the computer network to the remote electronic computer system 35, at least one of the user-interface specifications including a single user-interactive page 100. The single user-interactive page 100 includes two or more product elements 105, each product element 105 having two or more first product choices 110, and each first product choice 110 having two or more second product choices 115, wherein the product elements 105 are presented as selectable graphic product icons on the first portion 120 of the single user-interactive page 100, the first product choices 110 are presented as selectable graphic element icons on the second portion 122 of the single user-interactive page 100, and the second product choices 115 are presented as selectable graphic attribute icons on the third portion 124 of the single user-interactive page 100. Each of the selectable graphic element icons includes a representation of a selected product elements 105 or product choices 110, 115.

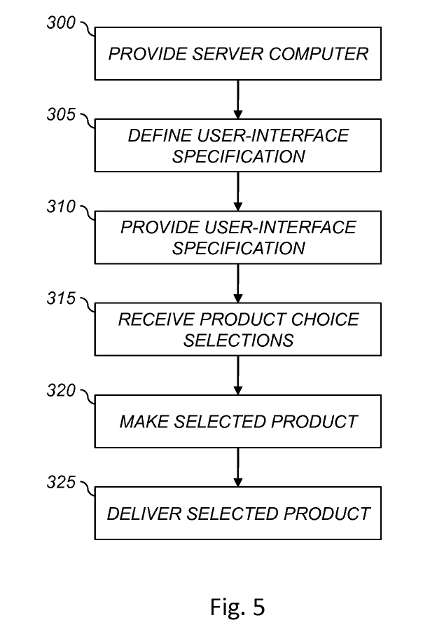

Thus, according to an embodiment of the present invention and as illustrated with FIG. 5, a method for efficiently enabling a user to specify elements in a product to specify the product includes providing the electronic computer system 20 connected to the remote electronic computer system 35, through a computer network (step 300). The electronic computer system 20 includes memory 40 for one or more defined user-interface specifications in a graphic user interface (step 305) that are communicated through the computer network to the remote electronic computer system 35, the remote electronic computer system 35, having the display 66 for displaying the user-interface specifications, and at least one of the user-interface specifications including a single user-interactive page 100 in a graphic user interface that includes user selections shown to the user 72 (step 310).

The electronic computer system 20 is used to enable a user selection of at least one product element 105 and at least two separate first product choices 110 that are shown to the user in the user-interactive page 100, wherein each first product choice 110 includes a representation of the selected product element 105. The electronic computer system 20 is further used to enable a user selection of one of the first product choices 110 and at least two separate second product choices 115 that are shown to the user in the user-interactive page 100 and each second product choice 115 includes a representation of the selected product element 105 and the selected first product choice 110. The electronic computer system 20 is also used to enable a user selection of one of the second product choices 115 in the user-interactive page 100 to specify the product with the product element 105, first product choice 110, and second product choice 115 (step 315).

In further embodiments of the present invention, the electronic computer system 20 is employed to make the specified product or to enable a third party to make the specified product (step 320). Alternatively, the specified product can be made by hand. Once constructed, the specified product can be delivered to the customer or provided to a third party for delivery to the customer (step 325).

When used herein, the term displayed image product refers to a representation of an image product shown in the graphic user interface of the display 66 and does not refer to the image product itself. Likewise, a view of an image product or a composited image product is a representation shown in the graphic user interface of the display 66. To select an image product or a composited image product is to preferentially indicate a representation of the image product or the composited image shown in the graphic user interface of the display 66. In common usage in the art, to display an image object is understood to mean the same thing as to display a view of the image object, and to select an image object is to preferentially indicate a view of the image object on a display screen. To make the selected composited image product is to physically render, manufacture, assemble, or fabricate it into an object, not to display a view of the composited image product. Likewise, a graphic icon represents a product element, element, or attribute and generally provides a recognizable view of the product element, element, or attribute (e.g. a thumbnail) rather than an abstract representation. A graphic icon, as used herein, can be a thumbnail, a small representation of the product, element, or attribute itself, that is a small image of the product, element, or attribute.

The computer system can include the electronic computer system 20 connected to the remote electronic computer system 35, through a computer network that provides communications between the electronic computer system 20 and the remote electronic computer system 35. In one embodiment of the present invention, the remote electronic computer system 35 includes a browser and the electronic computer system 20 includes web pages that are provided to the remote electronic computer system 35, through the computer network. Software for selecting a received image from a stored set of user images is employed, in another embodiment. Software for assigning a preferred status to each of the selected image products is included in yet another embodiment. Software for purchasing the selected image product, for example provided through electronic internet transaction services, is employed in one embodiment.

A variety of graphic user interfaces can be employed, for example one including software for displaying the selected subset of composited image product views on a different web page than the different image product views or for displaying the different web page on a different web-page-browser tab than the different image product views.

In another embodiment of the present invention, software for selecting from a large set of personalized-image-product elements includes software for interacting with the remote electronic computer system 35 through a computer network, the remote electronic computer system 35 having a graphical user interface (GUI), software for receiving one or more images, software for displaying a plurality of different image products or image product elements or attributes in the GUI on the remote electronic computer system 35, software for selecting a subset of the displayed image products or attributes, software for compositing a received image into each of the displayed image products or attributes in the selected subset to form a composited image product or attribute view for each of the selected image products or attributes, software for displaying the composited image product views in the GUI separately from the unselected image product views or attributes, software for selecting a desired displayed composited image product or attribute, and software for making the selected image product with the corresponding received image.

The software can include web pages that are provided from the electronic computer system 20 to the remote electronic computer system 35, through the computer network, software for selecting a received image from a stored set of user images, software for assigning a preferred status to each of the selected image products, software for purchasing the selected image product, and software for displaying the selected subset of composited image product views on a different web page than the different image product views.

As used herein, an image product can be a multi-media product, incorporating multiple different visual and auditory elements, both still and dynamic. According to various embodiments of the present invention, a multi-media product is an image product that includes a user's personalized images incorporated into an image-related object, such as for example a photo-book, a greeting card, a mug, or other image-related product. The images can be still images or image sequences, such as videos, and the multi-media product can include other media features, for example audio tracks, sounds, or sound sequences. A multi-media product can be a hard-copy product, for example a printed image together with an audio playback capability, or an electronic product, for example in an on-line album with still images, multiple still images, image sequences, sounds, a sequence of sounds, or audio tracks, or all of these. For simplicity and clarity of discussion, still images are described herein, but it is to be understood that the methods and objects described can include multi-media products that include images and can be either hard-copy or electronic and that the present invention includes these various embodiments.

The invention has been described in detail with particular reference to certain embodiments thereof, but it will be understood that variations and modifications can be effected within the spirit and scope of the invention.

### PARTS LIST

20 electronic computer system
22 housing
24 source of content data files
26 user input system
28 output system
29 printer
30 tangible surface
32 output device
34 processor
35 remote electronic computer system
36 electronic computer system
38 sensors
39 image sensors
40 memory
42 hard drive
44 disk drive
46 memory card slot
48 removable memory
50 memory interface
52 remote memory system
54 communication system
56 remote display
58 remote input
58a remote keyboard
58b remote mouse
58c remote control
66 local display

### Parts List Cont'd

68 local input
68a local keyboard
68b local mouse
70 home computer, editing studio, or kiosk
72 user
74 audio sensors
89 image sensor
100 single user-interactive page
105 product element
110 first product choice
115 second product choice
120 first portion
122 second portion
124 third portion
126 portion separator
128 selection box
128a, 128b, 128c selection box
130 multi-image product
135 scroll bar
140 arrowhead symbol
145 graphic command
150 pull-down menu collection indicator
200 provide graphic interface step
205 provide single interactive page step
210 present product elements step
215 receive user product element selection step
220 present first product choices with user selection step
225 receive first product choice selection from user step

### Parts List Cont'd

230 present second product choices with selected element and first product choice step
235 receive second product choice selection from user step
240 present selections to user step
245 receive purchase indication from user step
250 make specified product step
255 deliver specified product
300 provide server computer step
305 define user-interface specification step
310 provide user-interface specification step
315 receive product element selection step
320 make selected product step
325 deliver selected product step

1. A method for efficiently enabling a user to specify elements in a product to specify the product, comprising:
using a processor to provide a single user-interactive page in a graphic user interface that includes user selections shown to the user;
receiving a user selection of at least one product element and providing at least two separate first product choices that are shown to the user in the user-interactive page, wherein each first product choice includes a representation of the selected product element;
receiving a user selection of one of the first product choices and providing at least two separate second product choices that are shown to the user in the user-interactive page wherein each second product choice includes a representation of the selected product element and the selected first product choice; and
receiving a user selection of one of the second product choices to specify the product with the product element, first product choice, and second product choice.

2. The method of claim 1, wherein the specified product is an image product that includes one or more images.

3. The method of claim 1, further including displaying the product element in a first contiguous portion of the single user-interactive page, displaying the first product choice in a second contiguous portion of the single user-interactive page, and displaying the second product choice in a third contiguous portion of the single user-interactive page.

4. The method of claim 3, further including displaying the first portion at the left or top of the single user-interactive page, displaying the second portion at the left or center of the single user-interactive page, or displaying the third portion at the right or bottom of the single user-interactive page.

5. The method of claim 3, further including representing the product elements, first product choices, or second product choices with respective representative graphic icons and providing a scroll bar in at least one of the first, second, or third portions for scrolling through the graphic icons, or providing forward and back graphic icons for scrolling through the representative graphic icons.

6. The method of claim 3, further including displaying the first portion adjacent to the second portion and displaying the second portion adjacent to the third portion.

7. The method of claim 3, further including presenting a plurality of images as a slide show in at least one of the first, second, or third portions.

8. The method of claim 3, further including controlling the number of graphic icons in the first, second, or third portions.

9. The method of claim 1, further including defining a product element collection of product elements, a first product choice collection of first product choices, or a second product choice collection of second product choices and wherein the first product choices in the first product choice collection are dependent on the selected product element, and wherein the second product choices in the second product choice collection are dependent on the selected first product choice.

10. A user interface for efficiently enabling a user to specify elements in a product to specify the product, comprising:
a processor for generating a single user-interactive page in a graphic user interface that includes user selections shown to the user;
the processor enabling a user selection of at least one product element and a display representing at least two separate first product choices to the user in the user-interactive page, wherein each first product choice includes a representation of the selected product element;
the processor enabling a user selection of one of the first product choices and the display showing at least two separate second product choices to the user in the user-interactive page wherein each second product choice includes a representation of the selected product element and the selected first product choice; and
the processor enabling a user selection of one of the second product choices to specify the product with the product element, first product choice, and second product choice.

11. The user interface of claim 10, wherein the specified product is an image product that includes one or more images.

12. The user interface of claim 10, wherein the product element, first product choice, or second product choice includes images, templates, mattes, or frames.

13. The user interface of claim 10, wherein the display shows the product element in a first contiguous portion of the single user-interactive page, the first product choice in a second contiguous portion of the single user-interactive page, and the second product choice in a third contiguous portion of the single user-interactive page.

14. The user interface of claim 13, wherein the first portion is located at the left or top of the single user-interactive page, wherein the second portion is located at the left or center of the single user-interactive page or wherein the third portion is located at the right or bottom of the single user-interactive page.

15. The user interface of claim 13, wherein the first, second, or third portion includes a scroll bar for scrolling through a plurality of graphic icons or wherein the first, second, or third portion includes forward and back graphic icons for scrolling through a plurality of graphic icons.

16. The user interface of claim 13, wherein the first, second, or third portion can be changed in size through a graphic command or graphic operation.

17. The user interface of claim 13, wherein the number of graphic icons in the first, second, or third portions is controlled.

18. The user interface of claim 10, wherein at least one of the product elements, first product choices, or second product choices includes an image selected from a plurality of images shown on the display as a slide show.

19. The user interface of claim 10, wherein the product elements, first product choices, or second product choices are associated on the user-interactive page with a collection of product elements, first product choices, or second product choices, respectively, that is defined by the user.

20. The user interface of claim 19, wherein the display further includes showing one of the first or second collections of product elements, first product choices, or second product choices on the user-interactive page.

21. A computer system for efficiently enabling a user to specify elements in a product to specify the product, comprising:
a server computer connected to a remote client computer through a computer network, the server computer including storage for one or more user-interface specifications in a graphic user interface that are communicated through the computer network to the remote client computer, the remote client computer having a display for displaying the user-interface specifications, and at least one of the user-interface specifications including a single user-interactive page in a graphic user interface that includes user selections shown to the user;
wherein the display shows a single user-interactive page including a user selection of at least one product element and at least two separate first product choices and each first product choice includes a representation of the selected product element;
wherein the display shows the single user-interactive page including a user selection of one of the first product choices and at least two separate second product choices and each second product choice includes a representation of the selected product element and the selected first product choice; and
wherein the display shows the single user-interactive page including a user selection of one of the second product choices to specify the product with the product element, first product choice, and second product choice.

22. A method for efficiently enabling a user to specify elements in a product to specify the product, comprising:
providing a server computer connected to a remote client computer through a computer network, the server computer including storage for one or more user-interface specifications in a graphic user interface that are communicated through the computer network to the remote client computer, the remote client computer having a display for displaying the user-interface specifications, and at least one of the user-interface specifications including a single user-interactive page in a graphic user interface that includes user selections shown to a user;
using the server computer to enable a user selection of at least one product element and at least two separate first product choices that are shown to the user in the user-interactive page, wherein each first product choice includes a representation of the selected product element;
using the server computer to enable a user selection of one of the first product choices and at least two separate second product choices that are shown to the user in the user-interactive page and each second product choice includes a representation of the selected product element and the selected first product choice; and
using the server computer to enable a user selection of one of the second product choices in the user-interactive page to specify the product with the product element, first product choice, and second product choice.

23. The method of claim 22 further including making the specified product or enabling a third party to make the specified product.

24. The method of claim 22 further including delivering the specified product to the user or enabling a third party to deliver the specified product to the user.
